(19) United States
(12) Patent Application Publication
(10) Pub. No.: US 2012/0203643 A1
(43) Pub. Date: Aug. 9, 2012

(54) Retail Fuel Product Hedging Method

(75) Inventors: Edward Ross Levene, New Canaan, CT (US); Robert Sidney Levene, Weston, CT (US)

(73) Assignee: Energy Advantage, Inc., Stamford, CT (US)

(21) Appl. No.: 13/363,563

(22) Filed: Feb. 1, 2012

Related U.S. Application Data
(60) Provisional application No. 61/439,065, filed on Feb. 3, 2011.

(51) Int. Cl. G06Q 40/04; G06Q 30/02

(52) U.S. Cl. 705/14.73; 705/37

(57) ABSTRACT

New system and method that provides an efficient and cost-effective method for retail fuel dealers to offer their customers a fixed-price alternative, while shifting the risk of price volatility to a hedging entity, is disclosed. A fixed-price option is desired by many retail customers as an alternative to the well-established method of variable pricing based on day of delivery or purchase at the gasoline station pump. By efficiently aggregating retail customers from a number of retail dealers using a Fixed-Price Pricing Platform, a low-cost method is disclosed. Both the retail dealer and the retail customer maintain their traditional business relationship. The retail customer can avoid some or all of the risks of fuel price fluctuation over the term of the retail hedging contract with the dealer without the dealer having to take on any of the price fluctuation risks, as those risks are transferred to the hedging entity.

### CROSS REFERENCE TO RELATED APPLICATIONS

PROVISIONAL PATENT APPLICATION No. 6,149,065 dated 03 FEB. 2011

### BACKGROUND OF THE INVENTION

### Objects and Advantages

This invention provides a more efficient method for retail fuel dealers to offer their customers a fixed-price alternative to the well-established method of variable price based on day of delivery or day of purchase at the pump.

Many fuels fluctuate in price on a regular basis. The volatility of the fluctuation in heating oil and propane gas, as well as gasoline and diesel, depend heavily on supply and demand. In recent years prices have been increasingly influenced by speculation in the futures commodity market and other factors. The unpredictability and high degree of variability has motivated the retail customer to desire a fixed-price product. To accommodate this desire retail dealers have responded to the request for fixed-price arrangements, however, fluctuations in the commodity market over the past years have resulted in financial risk to the retail dealers with some dealers going out of business. For example, Connecticut has required heating oil and propane gas dealers to obtain a surety bond or have secured futures or forwards contracts or other such similar commitments for a defined percentage of its committed pre-paid or capped-price contracts (Connecticut General Statutes 16a-23n).

Currently, customers still desire a reasonably priced, fixed-price, or capped-price for their heating oil or propane gas seasonal requirements, but the retail dealer is not able to offer the product at a reasonable rate without taking on risk of commodity price fluctuation.

Prior patent 7,945,500 B2 (issued May 17, 2011) describes an insurance premium method for energy price protection. This patent describes a method whereby the consumer would pay an insurance premium to obtain price protection for a commodity purchase. Patent application US 2009/0198621 A1 (Aug. 6, 2009) describes a stand-alone energy price protection system. This application describes a method based on the consumer paying a protection amount to purchase a call option as well as the third party's costs and profit. Neither of these inventions, nor the prior art discussed in these documents, provide a low-cost method for a retail energy dealer to offer their customers a fixed-price or capped-price alternative without incurring risk of commodity price fluctuation over the period of the contract.

The present invention clearly describes an efficient method of providing retail energy dealers with the ability to offer customers a fixed-price option that doesn't require the dealer to take the risk of a fluctuating commodity market. This invention importantly maintains the dealer's ability to adjust its margin at the time of the offer to the customer. From the customer's perspective, the traditional customer-dealer relationship and services are provided.

### BRIEF SUMMARY OF THE INVENTION

In this invention, the retail commodity supplier provides its potential fixed-price customers a fixed-price, index-price, capped-price and/or a combination of those price offers from its fixed-price pricing platform. Definitions of these price plans are provided in the Detailed Description and these price plans are all encompassed by the term “Fixed-Price”. A computer-based system sets the consumer's Fixed-Price offer based upon the hedging entity's wholesale Fixed-Price to which the retail fuel supplier's delivery margin is added. The consumer's price will be fixed at the time of the contract between the parties for either a period of time or for a quantity of fuel, or both. In some embodiments, the hedging platform (the Fixed-Price Pricing Platform) is able to update the Fixed-Price offer over time as well as modify the consumer Fixed-Price offer based on the consumer's attributes (e.g. usage volume, tank size, competition and location). Wholesale hedging entities are structured to offer a Fixed-Price product for aggregated retail customer volume for each fuel commodity separately. The ability of the hedging platform to aggregate per fuel type, many customers of multiple retail dealers into a single package is a significant invention.

For retail fuel commodities, the invention will provide the individual retail fuel dealer additional market leverage to be able to offer an efficient Fixed-Price product. Once the consumer accepts the pricing agreement, the retail fuel dealer arranges to pick up the fuel and deliver or provide the fuel to the consumer as stated in the agreement. The exact method for handling credit and payment can vary between the customer, retail fuel dealer and the hedging entity. In one embodiment, the hedging entity receives delivery information, the customer pays for the fuel to the hedging entity, and the hedging entity pays the delivery margin to a delivery supplier.

The third party hedging entity may be a financial company, an insurance company, a wholesale commodity supplier, an investor(s), an integrated energy company or combinations of these firms.

### BRIEF DESCRIPTION OF THE DRAWINGS

FIG. 1 is a flow diagram that shows how a retail fuel customer arranges for fuel delivery by accepting a retail Fixed-Price offer through a retail Fixed-Price Pricing Platform.

FIG. 2 is a flow diagram that shows typical Hedging Entity roles and responsibilities.

FIG. 3 is a flow diagram for the Fixed-Price Pricing Platform.

FIG. 4 is a flow diagram detailing an embodiment of the invention for obtaining retail Fixed-Price gasoline.

### DETAILED DESCRIPTION

In the detailed description that follows a system is disclosed for retail energy products that will shift the risk of volatility in these commodities away from the retail purchaser and energy dealer, where it currently resides, to a third party hedging entity. The invention is accomplished by enhancing the way that the energy dealer and retail customer do business so that a hedging entity can offer a cost-efficient, effective way to offer hedges to a significant number of retail customers. Currently Heating Oil and Propane dealers are regularly asked by their customers to provide fixed-price and capped-price arrangements, however these dealers do not have commercially available options to cost-effectively transfer the entire risk of the fixed-price agreement to a third party.

Definition of “Fixed-Price”. Traditionally, retail fuel dealers sell their fuel product on a variable price. In this patent application, the term of art “Fixed-Price” refers to four somewhat different fixed-price products.
(a) “Fixed-Price” means a product that provides a single price per unit of fuel, as described in the offer or contract. For example, automatic delivery heating oil for the winter season for $3.50/gallon.
(b) “Fixed-Price” (also referred to as a “capped” price) means a product that provides a floating or variable price per unit of fuel, but caps the price at a fixed amount, as described in the offer or contract. For example, automatic delivery heating oil for the winter season at the dealer's daily posted price, but not to exceed $3.50/gallon.
(c) “Fixed-Price” (also referred to as an “index” price) means a product that provides a set price based on a publicly available index, as described in the offer or contract. For example, automatic delivery heating oil for the winter season at a price that is 50 cents above the next month heating oil contract price as listed on the New York Mercantile Exchange (NYMEX) for the day of delivery. Thus, for a heating oil delivery on a day when the NYMEX price for heating oil was $3.00 per gallon, the price for that day's delivery would be $3.50 per gallon.
(d) “Fixed-Price” (also referred to as a “capped index” price) means a product that provides a set price based on a publicly available index, but caps the price at a fixed amount, as described in the offer or contract. For example, automatic delivery heating oil for the winter season at a price that is 50 cents above the next month heating oil contract price as listed on the NYMEX for the day of delivery, but not to exceed $3.50 per gallon. Thus, for a heating oil delivery on a day when the NYMEX price for heating oil was $3.05 per gallon, the price for that day's delivery would be $3.50 per gallon.

In one embodiment of the invention Energy Dealers offers the Retail Energy Customer the ability to lock in a Fixed-Price or Capped-Price through the use of a Fixed-Price Pricing Platform. The Fixed-Price Pricing Platform allows many retail customers' usage to be aggregated so that Hedging Entities will be able to provide pricing for the aggregated volume with more efficient costs. The Fixed-Price Pricing Platform combines the Hedging Entity's wholesale fixed-price offer with Energy Dealer's margin creating the Retail Fixed-Price product.

After a retail energy customer agrees to a specific Retail Fixed-Price, as well as the terms and conditions of the Fixed-Price contract, the Energy Dealer delivers the energy product (e.g. heating oil, fuel or propane) pursuant to the Retail Fixed-Price product contract with the consumer.

The Energy Dealer provides delivery information to the Hedging Entity including account information and pricing information.

When the Hedging Entity has arranged for the energy product to be available for pickup by the Energy Dealer at a terminal or delivered to the dealers distribution tank(s), the purchase of the wholesale product is controlled by the Hedging Entity. However, when an agreement between the Hedging Entity and the Fuel dealer does not require that the Hedging Entity take physical delivery of the product, the Hedging Agreement between the Hedging Entity and the Fuel Dealer will describe an alternative method.

A Retail Energy Customer enters into contract with Energy Dealer for Retail Fixed-Price product, which provides the consumer with a known unit price for a fixed or capped-price product for the length of the contract. The offering price of the contract may vary frequently, but once the contract is executed, the price for that contract is known.

Retail Energy Customer is billed the Retail Fixed-Price Contract Rate per unit delivered.

To provide efficient hedging when the quantity is not predetermined, Retail Energy Customer may be required to commit to automatic delivery, by agreeing to purchase their total requirements of the energy product using the contract. Alternatively, Retail Energy Customer may agree to a maximum quantity and/or minimum quantity that is allowed or required to be purchased using the contract.

The Fixed-Price Pricing Platform may also include an opt-out or buy-out pricing mechanism which defines a method of calculating the price at a given time during the contract period for a retail customer to prematurely end the contract.

In order to more accurately know that the product was delivered to the Retail Energy Consumer, the contract may require that the Customer's tank(s) be equipped with an automatic volume monitoring device that can be read remotely.

While the Hedging Entity provides risk control for the volatility of the price of the fuel product to the consumer, the Energy Dealer can focus on its core competency of providing retail energy services.

The Hedging Agreement between the Hedging Entity and the Energy Dealer provides the Energy Dealer with an ability to offer its customers a Fixed-Price offer that includes a known Energy Dealer margin.

The Hedging Entity is informed by Energy Dealer of enrollments; customer information, including information to estimate usage and usage volatility, if desired; and Energy Dealer margin.

The Hedging Entity benefits by using its expertise in trading these commodities and gains access to a market it was not previously participating in. The Hedging Entity might be a financial services company, an integrated energy company, an insurance company, a commodity trader, or an investor or combination of the above entities.

The Retail Customer benefits from the opportunity of having a Fixed-Price offering that is provided by an entity with expertise in hedging.

The Energy Dealer benefits by allowing the company to be assured of a known margin on Fixed-Price contracts, so that the Energy Dealer can focus on improving its business processes that are within its control; delivery of the product, customer service, sales, administration, business development and employee performance.

Various embodiments of the disclosure are illustrated in the FIGURES. Although the figures focus on the business relationship of the retail energy dealer, the hedging entity and the retail fuel customer, the disclosure is applicable to the retail purchases of any commodity.

A retail fuel is distinguished from a wholesale fuel in that the purchaser of a retail fuel is typically the consumer of the fuel. The risk to the retail consumer of significant price fluctuations in commodity markets has become much more pronounced as commodity speculators have been accused of causing market moves.

In a preferred embodiment, the computer equipment to accomplish the Fixed-Price pricing platform will be communicatively coupled to the internet so that the retail fuel dealer, or alternatively a marketing company or the retail customer, will be able to bid for or accept the Retail Fixed-Price Product.

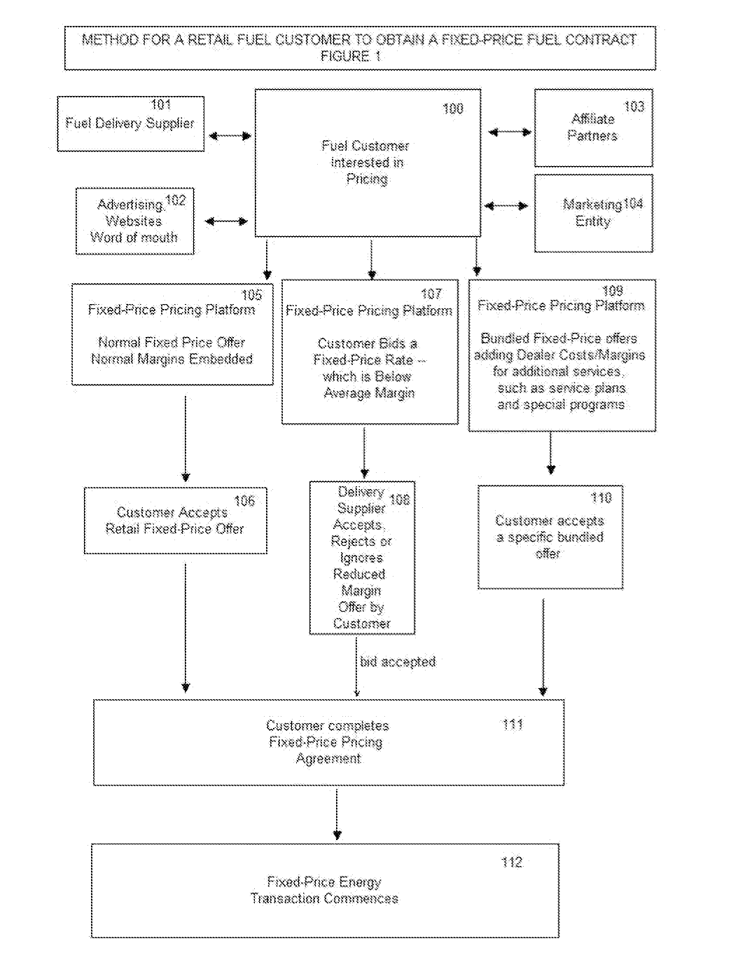

FIG. 1 shows a flow diagram illustrating embodiments of the invention from the vantage point of the fuel customer. Fuel customer 100 may be contacted by or contact the fuel delivery supplier 101, may see or hear about the Fixed-Price product from advertising, websites, word or mouth 102, may be contacted by or contact affiliate partners 103, such as school groups, church groups, buying groups, or work groups, or may be solicited by marketing entities 104, that are expanding the customer base of the pricing platform for remuneration. These are just a few examples of the many different ways that a potential customer may be introduced to the Fixed-Price platform offers. FIG. 1 then shows three examples of processes that may result in a retail Fixed-Price product contract. It is expected that many retail customers will be informed of the normal Fixed-Price offers which has the hedging entity's wholesale Fixed-Price and the fuel delivery company's margin embedded 105. If the retail customer desires the offered Fixed-Price, the customer accepts the desired retail Fixed-Price offer 106. The second example process shows a customer, or affinity group, bidding for a Fixed-Price rate 107. The fuel delivery company can accept the bid at a reduced margin 108, or can reject the bid, or can ignore the bid until the combination of the wholesale Fixed-Price and the fuel delivery margin hit the bid amount. The third example shows a process whereby the retail Fixed-Price offer is bundled with other services 109. Once again, when the customer or customer group is satisfied with the offer presented on the Fixed-Price Pricing Platform, the customer or customer group accepts the offer 110. The flow diagram shows that a retail Fixed-Price product can be accepted using any of the three processes. In addition to accepting the fixed-price (or index-price or capped-price) per unit, the customer executes the dealer agreement which states the terms and conditions of the contract 111. After the retail Fixed-Price contract is in place, the Fixed-Price energy transaction commences 112.

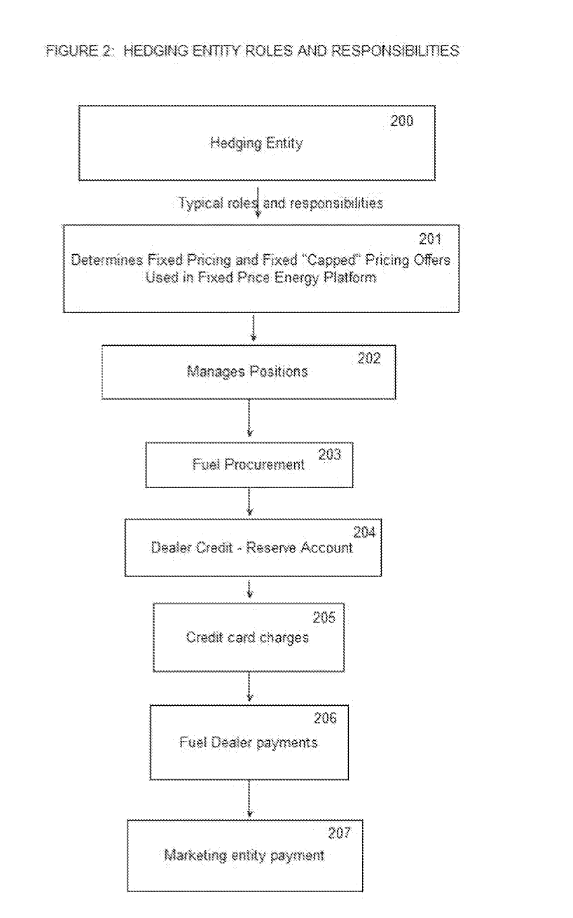

FIG. 2 illustrates the typical roles and responsibilities of the Hedging Entity 200. Certain financial responsibilities under the Hedging Entity will be determined by the parties and adjusted from time to time based on the parties' strengths, desires, and cost impact. For example, the customer credit risk associated with whether the retail customer makes good on payment, will likely be the responsibility of the Energy Dealer, as it is typically done now. However, where an Energy Dealer finds the cost of carrying accounts is high or where an Energy Dealer has limited or expensive lines of credit, the Hedging Entity may assume the credit risk. This invention recognizes that the financial business functions are capable of being done by either party or by a third party. The financial responsibilities for energy product pickup, billing and payment arrangements will be defined in the Hedging Agreement between the Hedging Entity and the Energy Dealer. A main responsibility of the hedging entity is to determine the fixed pricing and fixed “capped” pricing offers used in the Fixed-Price Energy Platform 201. Since these pricing offers and resulting contracts are for physical commodity products, they do not constitute “futures contracts” that require the retail participants to execute the contracts on the floor of a commodity exchange and comply with other CFTC (Commodities Futures Trading Commission) regulations. These physical commodity contracts provide an outlet for the hedging entity for the physical product that underlies CFTC regulated “futures contracts”. Another main responsibility of the hedging entity is to manage the commodity positions 202, whether it's in physical product, futures contracts, and/or options, refinery output, shipments of fuel to terminals, shipments to and from pipelines, shipments to storage or withdrawal for storage or trucking to dealer facilities. Fuel production, procurement, storage and transportation 203 may or may not be a responsibility of the hedging entity. The method for procuring the fuel that is then delivered to the Fixed-Price retail customer may vary over time, but will be agreed to between the retail fuel dealer and the hedging entity. To the extent the hedging entity needs financial assurance that the fuel dealer will be financially responsible, the terms and conditions of the contract between the hedging entity and the fuel dealer will govern dealer credit requirements 204. In a preferred embodiment, the retail customer uses a pre-approved credit card 205 to pay for the retail Fixed-Price contract. For some fuel products, such as heating oil, certain credit card companies may offer a reduced fee, and taking advantage of that savings makes the Fixed-Price contract more efficient. Once the transaction between the fuel dealer and the retail customer has commenced, the fuel dealer will receive his margin payments from the financial hedging entity 206. In the alternative, the fuel dealer could take the payments directly from the consumer and be responsible for sending payments to the hedging entity. If a marketing entity brought the customer to the retail Fixed-Price contract, then a payment to the marketing entity would most likely be made by the hedging entity. However, in the alternative, the fuel dealer may by contract be responsible for the payments to the marketing entity.

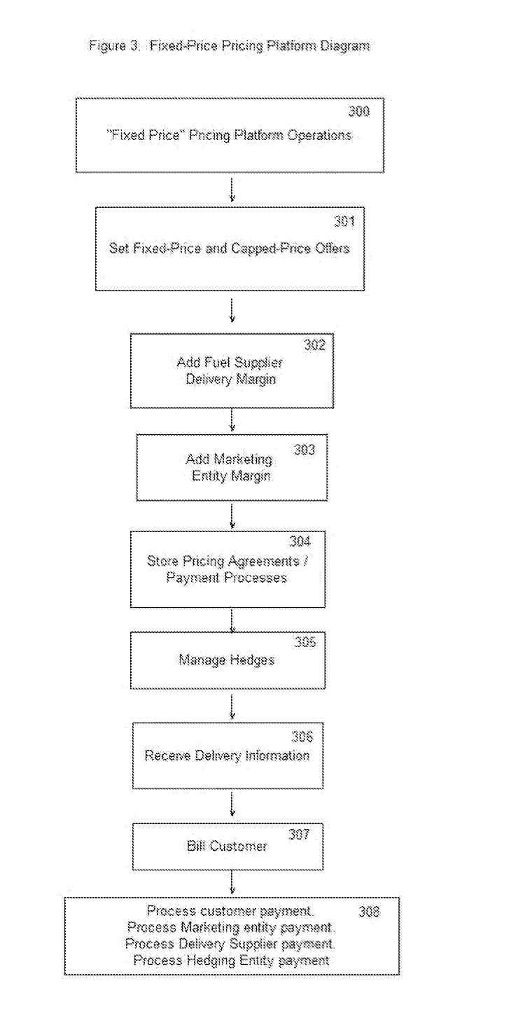

FIG. 3 illustrates some of the operations that can be incorporated into the “Fixed-Price” Pricing Platform 300. The platform's main purpose is to provide to potential customers the fixed-price offers. The Hedging Entity will set the wholesale Fixed-Price offers 301. In one embodiment, each retail fuel dealer will have a separate secure area where the fuel dealer determines a standard delivery or custom margin 302, as well as manages the “case by case” requests from marketing entities, affiliate groups and individual customers. In this embodiment, only the fuel dealer will have access to the fuel dealer's secure area. This embodiment parallels the process currently used by retail heating oil and propane dealers for variable price customers.

In addition to the wholesale Fixed-Price component and the fuel dealer's margin component, the pricing platform can add applicable marketing entity margin(s) 303. The pricing platform is capable of having these component parts be modifiable provided the security considerations are met. Then, a potential customer could evaluate the Fixed-Price options available over time and arrange for a specific Fixed-Price contract without any direct contact with the fuel dealer. As shown in FIG. 3, the pricing platform can be used to store pricing agreements and payment processes 304 as well as manage hedges 305, receive delivery information 306, and bill the customer 307. In addition, the Fixed-Price platform may process customer payments, process the marketing entity payments, process the delivery supplier payments and process the hedging entity payments 308.

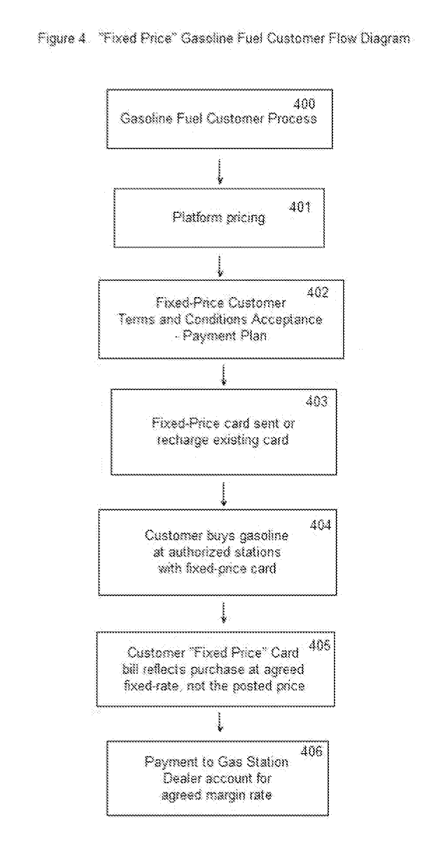

FIG. 4 illustrates an embodiment of the Retail Fixed-Price Hedging Method as it relates to retail gasoline sales. Retail gasoline fuel delivery is somewhat different than heating oil and propane fuel delivery in that the retail customer is accustomed to driving to the filling station, since cars are mobile, whereas retail heating oil and the larger propane tanks are ordinarily stationary. Therefore, the Fixed-Price hedging method described for heating oil and propane is similar, whereas the retail gasoline Fixed-Price method mechanics has some notable differences. The retail gasoline filling station desires an efficient mechanism for arranging for Fixed-Price gasoline without taking on the risks of a fluctuating commodity market. The enhanced efficiency of this invention over prior art is due to dealers being able to compete for retail business on the basis of Fixed-Price offers. Other than customers that choose the Fixed-Price alternative, regular gas station customers will still be charged the posted price. Hedging entities, desiring to increase the volume of physical product usage under their control, will be competing for new aggregated blocks of retail physical product users and dealers, through the offering of a product that retail customers want. Dealers will have a method to become a preferred supplier for retail customers desiring a fixed price, while maintaining their margin requirements.

Similarly to FIG. 1, the invention depends on aggregating retail customers using a Fixed-Price Pricing Platform 401. When the customer agrees to the Fixed-Price offer, the customer accepts the terms and conditions including the payment plan 402. One embodiment of the gasoline process is that a Hedging Entity will arrange for a Fixed-Price card to be sent to the customer, or the customer's existing Fixed-Price card to be recharged 403. The customer buys gasoline at an authorized station with the Fixed-Price card 404. Although the posted price at the pump will be the variable rate charged to the non-contract customer, the customer using the Fixed-Price card will have the bill reflect the retail Fixed-Price rate and the quantity of gasoline purchased 405. As part of the transaction the gasoline dealer receives it's agreed upon margin. As described in the terms of the Hedging Agreement, the Hedging Entity may deliver or arrange for delivery of gasoline to the filling station on behalf of the station owner, lease operator or supply contract entity. If the gas station is contracted to receive its fuel from a specified company or if the gas station is part of a larger company, these considerations will be taken into account in the Hedging agreement, which may result in a multi-party agreement 406.

Various embodiments disclosed herein describe business practice alternatives that are well-known, in that one contract partner or another, or a third-party, performs necessary marketing, sales, legal, financial, hedging, computer services, product operations, safety and environmental responsibilities, and customer service. This invention, through the use of a Fixed-Price Pricing Platform discloses a method of aggregating a sufficient quantity of retail customers in an efficient manner so that hedging entities are competing for the retail Fixed-Price market and the retail commodity dealer is not subject to the risks of fluctuating commodity prices.

Although embodiments have been described in detail herein, these descriptions are by way of example only and are not to be construed to limit the disclosure of the invention. Many changes in the details of the embodiments and additional embodiments will be apparent, and may be made by persons of ordinary skill in the art having reference to this description. These changes and additional embodiments are considered within the scope of the claims below.

What is claimed is:

1. A method for a retail commodity dealer to provide to potential customers one or more Fixed-Price products which is defined to include fixed-priced products, index-priced products, capped-priced products and capped index-priced products comprising:
a retail Fixed-Price product which is the wholesale Fixed-Price as determined by the hedging entity and the additional delivery margin price that is acceptable to the retail commodity dealer;
providing an interactive electronic database system where numerous retail customers can arrange to be served under retail Fixed-Price contracts thus providing an aggregated volume of retail commodity throughput that is attractive for various hedging entities:

2. The method of claim 1, where the Fixed-Price product offers are contained in an interactive Fixed-Price Pricing Platform;

3. The method of claim 1, where the commodity is a fuel, including heating oil, propane, and gasoline and diesel fuel.

4. The method of claim 1, where the fixed-price product also includes a capped-price product, an index-price product and an index-price with a cap product.

5. The method of claim 1, where the retail commodity dealer offers different retail fixed-price products to different customers.

6. The method of claim 1, where additional fees are included in the retail fuel customer fixed-price offer to cover other charges such as third party marketing, financial services, and other bundled offers.

7. A system for the retail Fixed-Price Pricing Platform to market Fixed-Price offers in commodity products to a plurality of users comprising:
an applications server,
a web server,
and a database server;
wherein the applications server is electronically connected to the hedging entity source of wholesale fixed pricing for the commodity and the retail commodity dealer can vary its margin requirements to calculate the retail fixed-price offer;
wherein the web server is connected to the applications server to effectively communicate pricing information to users via web pages or email;
wherein the web server is connected to a database server; and
wherein the Fixed-Price Pricing Platform contains the customer information as well as the contract terms and conditions;
and further the system comprises security features that prevent unauthorized user access to the platform and the database server.
